(19) United States
(12) Patent Application Publication
(10) Pub. No.: US 2025/0193929 A1
(43) Pub. Date: Jun. 12, 2025

(54) Flexible Frame Structures for Directional Unlicensed Access in Sub-Terahertz Band

(71) Applicant: Apple Inc., Cupertino, CA (US)

(72) Inventors: Mikhail WILHELM, Munich (DE); Biljana BADIC, Munich (DE); Christian DREWES, Germering (DE); Jan K. ELLENBECK, Gruenwald (DE); Norman GORIS, Dortmund (DE); Stefan MEYER, Hoechstadt (DE)

(21) Appl. No.: 18/534,028

(22) Filed: Dec. 8, 2023

(51) Int. Cl. H04W 74/08

(52) U.S. Cl. CPC H04W 74/0816

(57) ABSTRACT

A system including a user equipment (UE) configured to receive channel access scheduling information that includes at least one frame with a configurable number of data transmission slots, wherein the frame includes a downlink signaling phase, a data transmission phase, an additional scheduling phase and an additional data transmission phase and transmit data and clear channel assessment (CCA) information, wherein the data and the CCA information are transmitted in one or more data transmission slots selected from the configurable number of data transmission slots based on the channel access scheduling information and an access point (AP) configured to transmit the channel access scheduling information to the UE and receive the data and clear channel assessment (CCA) information from the UE.

### BACKGROUND

The sub-THz frequency range is a promising candidate for 6G wireless networks mainly due to the huge bandwidth enabling transmission of hundreds of Gigabits per second (Gbps). However, the sub-THz frequency range also introduces additional complexity compared to an omni-directional system, as new hardware and technology to cope with the high frequency range is required. In the case of unlicensed spectrum, beam handling and user equipment (UE) access is getting even more complicated due to a variety of factors.

The sub-THz spectrum is envisioned to be used by applications requiring high data rate and low latency communication links. The spectrum is expected to be operated in an unlicensed way. Therefore, reliably providing low latency and high data rate might be challenging due to spectrum sharing. Typically, random access techniques (e.g., Carrier Sense Multiple Access/Carrier Aggregation (CSMA/CA) are used in unlicensed spectrum; however, due to the high directivity of sub-THz communication and the need for beam establishment and tracking, random access cannot be applied and scheduled access must be used. Random access techniques also suffer from high power consumption since duty cycling drastically increases latency (duty cycles are uncoordinated). Scheduled access, however, also has potential problems when applied in the unlicensed spectrum, such as potential wasted communication resources and latency.

It has been identified that there is a need to provide methods, devices, and flexible frame structures for supporting directional unlicensed access in the sub-THz band.

### SUMMARY

Some example embodiments are related to a system including a user equipment (UE) configured to receive channel access scheduling information that includes at least one frame with a configurable number of data transmission slots, wherein the frame includes a downlink signaling phase, a data transmission phase, an additional scheduling phase and an additional data transmission phase and transmit data and clear channel assessment (CCA) information, wherein the data and the CCA information are transmitted in one or more data transmission slots selected from the configurable number of data transmission slots based on the channel access scheduling information. The system also includes an access point (AP) configured to transmit the channel access scheduling information to the UE and receive the data and clear channel assessment (CCA) information from the UE.

Other example embodiments are related to an apparatus of a user equipment (UE), the apparatus comprising processing circuitry configured to decode, from signaling received from an access point (AP), channel access scheduling information that includes at least one frame with a configurable number of data transmission slots and configure transceiver circuitry to transmit data and clear channel assessment (CCA) information to the AP, wherein the data and the CCA information are transmitted in one or more data transmission slots selected from the configurable number of data transmission slots based on the channel access scheduling information.

Still further example embodiments are related to an apparatus of an access point (AP), the apparatus comprising processing circuitry configured to configure transceiver circuitry to transmit channel access scheduling information to one or more of a plurality of user equipment (UE(s)), the channel access scheduling information including at least one frame with a configurable number of data transmission slots and decode, from signaling received from one or more of the plurality of UEs, data and clear channel assessment (CCA) information, wherein the data and the CCA information are transmitted in one or more data transmission slots selected from the configurable number of data transmission slots based on the channel access scheduling information.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 is an example Scheduled Channel Access Frame Structure for scheduling directional unlicensed access according to example embodiments.

FIG. 5 is an example Scheduled Channel Access Frame Structure highlighting an example DL signaling phase and additional signaling phase according to example embodiments.

FIG. 6 is an example Scheduled Channel Access Frame Structure highlighting an example data transmission phase according to example embodiments.

FIG. 7 is an example diagram illustrating an example channel sensing period in an example Scheduled Channel Access Frame Structure according to example embodiments.

FIG. 8 is an example diagram illustrating an example additional signaling phase in an example Scheduled Channel Access Frame Structure according to example embodiments.

FIG. 9 is an example flow diagram illustrating exchange of information between an AP and a UE in an example additional signaling phase according to example embodiments.

### DETAILED DESCRIPTION

The example embodiments may be further understood with reference to the following description and the related appended drawings, wherein like elements are provided with the same reference numerals. The example embodiments relate to wireless communication devices, and in particular relate to methods, devices, and flexible frame structures for supporting directional unlicensed access in the sub-Terahertz (sub-THz) band.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a fifth generation (5G) New Radio (NR) network and a next generation node B (gNB). However, reference to a 5G NR network and a gNB is merely provided for illustrative purposes. The example embodiments may be utilized with any appropriate type of network (e.g., 5G-Advanced network, 6G network, etc.) and base station.

The UE may perform measurements on one or more neighbor cells using a specific downlink reference signal, e.g., a signal synchronization block (SSB) or a channel state information (CSI)-reference signal (RS). The measurements may be based on SSB, CSI-RS or any other appropriate downlink resource. The measurement metric may be L1-reference signal received power (RSRP), L1-signal interference-to-noise ratio (SINR), L1-reference signal received quality (RSRQ) or any other appropriate type of metric. However, any reference to a specific type of measurement, reference signal or metric is merely provided for illustrative purposes. The example embodiments may apply to any appropriate type of measurement, reference signal or metric.

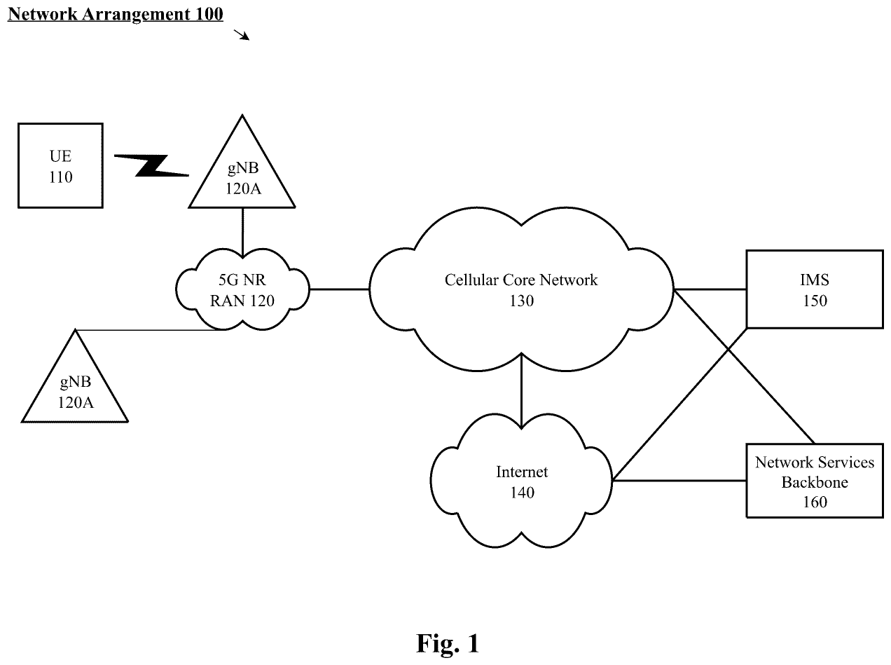

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the example embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. As used herein, the term “base station,” “access node,” “access point,” or the like may describe equipment that provides the radio baseband function for data and/or voice connectivity between a network and one or more users. These access nodes can be referred to as BS, gNBs, RAN nodes, eNBS, NodeBS, RSUs, TRxPs or TRPs, and so forth, and can comprise ground stations (e.g., terrestrial access points) or satellite stations providing coverage within a geographic area (e.g., a cell). In fact, some embodiments, a UE, such as UE 110 described herein, may function as an access point.

In the network arrangement 100, the 5G NR PAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

Any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

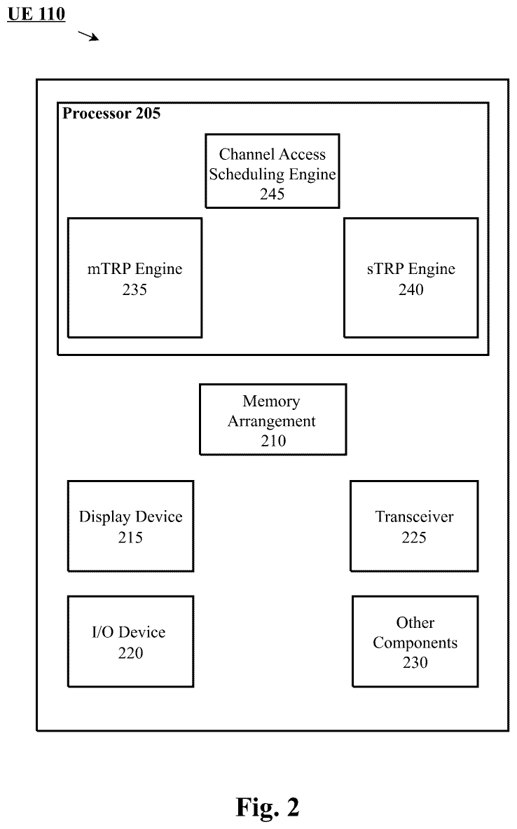

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a mTRP engine 235, a sTRP engine 240, and a channel access scheduling engine 245. The mTRP engine 235 may perform various operations related to mTRP operation. The sTRP engine 240 may perform various operations related to sTRP operation. In 5G NR, a unified transmission configuration indicator (TCI) framework is intended to facilitate streamlined mTRP operation. To provide some general examples, the mTRP engine 235 may perform operations such as, but not limited to, dynamically switching between mTRP mode and sTRP mode, updating a CC-group for mTRP operation and determining a default downlink beam/TCI-state for mTRP PDSCH reception. The channel access scheduling engine 245 may perform whatever steps are necessary to schedule channel access for data transmissions to and from the UE 110, such as between the UE 110 and an access point (AP).

The above referenced engines 235, 240, and 245 being applications (e.g., a program) executed by the processor 205 is merely provided for illustrative purposes. The functionality associated with the engines 235, 240, and 245 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

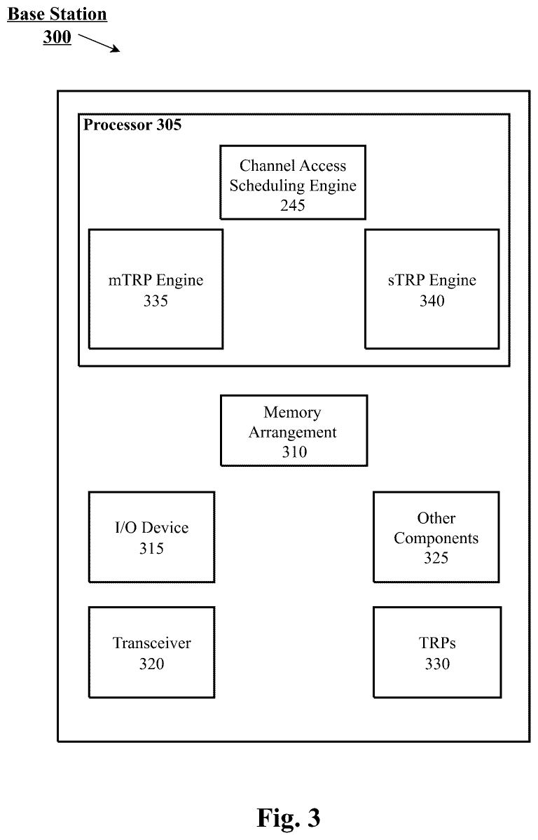

FIG. 3 shows an example base station 300 according to various example embodiments. The base station 300 may represent the gNB 120A or any other type of access node through which the UE 110 may establish a connection and manage network operations. As used herein, the term “base station” may also refer to an “access node,” “access point,” or the lie and may describe equipment that provides the radio baseband functions for data and/or voice connectivity between a network and one or more users. These base stations and access nodes can be referred to as BS, gNBs, RAN nodes eNBs, Nodes, RSUs, RP or TRP, and so forth, ad can comprise ground stations (e.g., terrestrial access points) or satellite stations providing coverage with in a geographic area (e.g., a cell).

The base station 300 may include a processor 305, a memory arrangement 310, an input/output (I/O) device 315, a transceiver 320, multiple TRPs 330 and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

As indicated above, in some scenarios, the multiple TRPs 330 may be deployed locally at the base station 300. In other scenarios, one or more of the multiple TRPs 330 may be deployed at physical locations remote from the base station 300 and connected to the base station via a backhaul connection. The base station 300 may be configured to control the multiple TRPs 330 and perform operations such as, but not limited to, assigning resources, configuring reference signals, implementing beam management techniques, etc.

The processor 305 may be configured to execute a plurality of engines for the base station 300. For example, the engines may include a mTRP engine 335, a sTRP engine 340, and a channel access scheduling engine 345. The sTRP engine 340 may perform various operations related to sTRP operation. The mTRP engine 335 may perform various operations related to mTRP operation. To provide some general examples, the mTRP engine 335 may perform operations such as, but not limited to, transmitting a signal to trigger the UE 110 to dynamically switch between mTRP mode and sTRP mode, transmitting information to update a CC-group for mTRP operation and indicating a default downlink beam/TCI-state for mTRP PDSCH reception. The channel access scheduling engine 345 may perform whatever steps are necessary to schedule channel access for data transmissions to and from the base station 300, such as between the base station 300 and the UE.

The above noted engines 335, 340, and 345 being applications (e.g., a program) executed by the processor 305 is only example. The functionality associated with the engines 335, 340, and 345 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The example embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

As previously mentioned, the sub-THz frequency range is a promising candidate for 6G wireless networks mainly due to the huge bandwidth enabling transmission of hundreds of Gbps. Due to the high directivity required in sub-THz systems, eavesdropping is much harder compared to omni-directional systems and a higher privacy level is achieved by default. However, the sub-THz frequency range also introduces additional complexity compared to an omni-directional system. For example, new hardware and PA technology to cope with the high frequency may be required. Due to the huge pathloss, mainly indoor use-cases with limited range will be relevant. To overcome the pathloss, a high antenna gain achieved via antenna arrays with a large number of antennas is required, which may result in narrow beams for all data transmissions.

In addition, in the case of unlicensed spectrum, beam handling and UE access is even more complicated due to the following facts. Unlike in 3GPP scenarios, conflicts between different users of the same radio access technology (RAT) or different RATs using the same spectrum might occur. Regulation might require directional (i.e., beamformed) clear channel assessments (beamformed listen-before-talk (LBT)). Multi-user scheduling and coordination are much more difficult compared to licensed spectrum usage.

The sub-THz spectrum is envisioned to be used by applications requiring high data rate and low latency communication links. The spectrum is expected to be operated in an unlicensed way. Therefore, providing reliability, low latency, and high data rate may be challenging due to spectrum sharing. For example, there are spectrum access rules, such as the EU harmonized standard ETSI EN 302 567, which may be extended to sub-THz. Channel access rules may apply, such as “short control signaling.” For example, channel access rules may include transmission (Tx) for up to 10 milliseconds (ms) out of 100 ms without any restrictions allowed where normal transmissions having a maximum channel occupancy time (COT) of 5 ms, with 8 microsecond (us) idle periods between/before 5 ms COT periods. However, these are only examples as there are no current regulatory requirements for sub-THz and the exemplary embodiments may be implemented in networks that apply any type of channel access rules or corresponding parameters for the channel access rules.

Typically, random access techniques (e.g., CSMA/CA) are used in unlicensed spectrum, however, due to high directivity of sub-THz communication and the need for beam establishment and tracking, random access cannot be applied and scheduled access must be used. Random access techniques also suffer from high power consumption since duty cycling drastically increases latency (duty cycles are uncoordinated). Scheduled access, however, has the following problems when applied in unlicensed spectrum. Access reservation, clear channel assessment (CCA), and channel sounding must be performed to avoid collisions and plan data transmissions. In addition, if a channel is lost due to sensing, communication resources (e.g., the frame) are wasted and latency is introduced until the next scheduled period.

To maximize resources and to reduce latency, novel methods, devices, and flexible frame structures for supporting directional unlicensed access in the sub-Terahertz (sub-THz) band are proposed. Wi-Fi uses CSMA/CA in order to reserve access and avoid collisions. CSMA/CA provides high spectrum utilization and allows full channel occupancy time utilization, but does not work at all, or at least not well, for directional access, since beamforming requires prior coordination and synchronization between transmitter and receiver. Sixty GigaHertz (60 GHz) WiFi (Wi-Gig) uses scheduled access and fixed frame lengths, which allows users to synchronize to an access point (AP) and to perform beam sweeps. However, Wi-Gig only has one scheduling period per frame (i.e., beacon period of typically >100 ms), which may create high latency and under-utilization of the medium access if new data arrives, or if the channel is sensed busy during the transmission phase. Long term evolution (LTE) wireless systems and NR unlicensed systems use scheduled access, combined with clear channel assessment (CCA) prior to every transmission, which can allow low-latency transmission and flexible resource allocation. However, these systems need CCA and grant in every slot, as well as separate resources for channel sounding, which may create additional overhead.

According to certain aspects of this disclosure, a variety of approaches may be considered to efficiently support directional unlicensed access in sub-Terahertz (sub-THz) band, without wasting resources or having high latency. In one embodiment, a flexible frame structure for directional unlicensed access is proposed. Scheduled channel access is provided in the unlicensed band. A method to schedule multiple UEs using frames with a configurable number of data transmission slots is proposed, some of which include a channel sensing period, which combines channel sounding, CCA, and access reservation mechanisms. The proposed method is designed to allow scheduled operation in the unlicensed spectrum and reduce overhead.

The method also includes the designation of backup scheduling UEs, which may provide flexibility in the case of UE-specific CCA failure while allowing most UEs to sleep and save power. Also proposed is a procedure and signaling scheme to extend and/or reconfigure the frame if a channel is sensed busy, or if new data arrives in the buffer, which may reduce latency and increases frame utilization for scheduled access. In this manner, a solution for low-latency scheduled access is introduced, reducing the latency due to channel sensing and unpredictable traffic patterns.

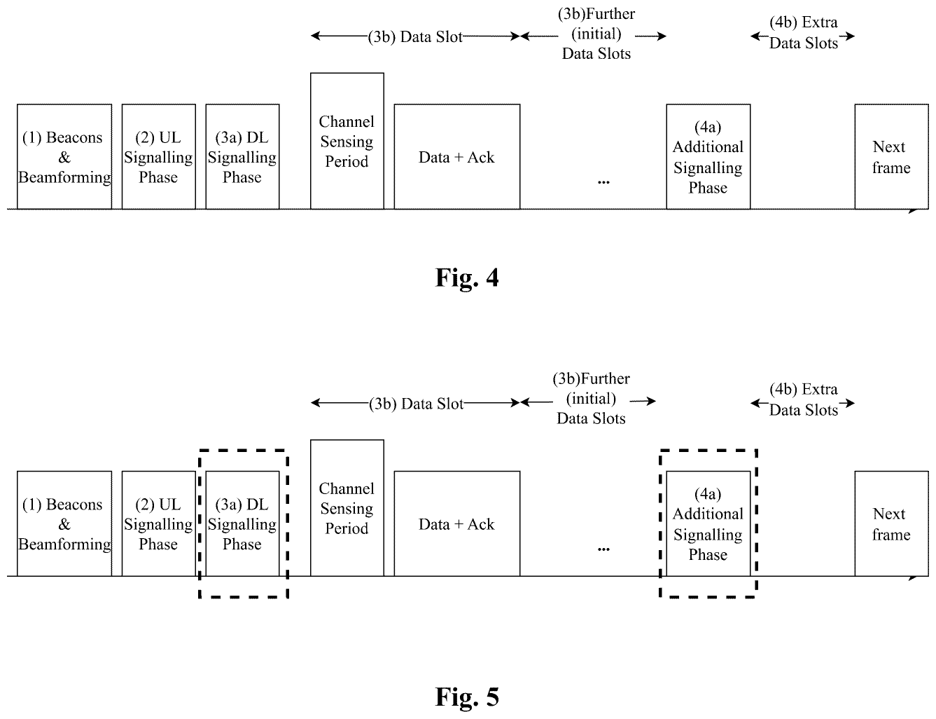

In some example embodiments, a Scheduled Channel Access Frame Structure is disclosed. FIG. 4 is an example Scheduled Channel Access Frame Structure for scheduling directional unlicensed access according to example embodiments. Channel access is organized in frames. A frame duration is chosen to match a maximum Channel Occupancy Time (COT) allowed by applicable standards or regulations in one embodiment. To provide some examples, in some example embodiments, the maximum COT may be five milliseconds (5 ms), in other example embodiments, the maximum COT may be 10 ms. However, these are only examples and other durations may be selected. Choosing the frame duration to match the maximum COT allows simplified access reservation due to COT sharing and/or reduces overhead when only a small number of UEs or a small number of transmission directions are used during the frame. In one embodiment, as seen in FIG. 4, each frame includes: (1) a beacon and beamforming period; (2) an uplink (UL) signaling phase; (3a) a downlink (DL) signaling phase; (3b) a data transmission phase; (4a,b) one or more additional signaling phase(s) similar to the initial signaling phase. Phases 1 and 2 provide mechanisms for UEs to access the system, to establish and maintain beam alignment between an access point (AP) and a UE, and to request scheduling via uplink signaling. The UE may transmit to the AP during the UL signaling phase. For example, the UE may inform the AP of its buffer status and how much data it may need. Phases 3a/b and 4a/b are described in further detail below.

### DL Signaling Phase

FIG. 5 is an example Scheduled Channel Access Frame Structure highlighting an example DL signaling phase and additional signaling phase according to example embodiments. Referring to FIG. 5 and in particular, the (3a) DL signaling phase, the DL signaling phase is assumed to be performed omnidirectionally on the AP side to reach all UEs, while the UEs perform beamforming towards the AP. Beam alignment achieved in a prior phase is not covered here, but is done via known techniques. The DL signaling is configured to deliver information to all UEs about the timing and direction of upcoming data transmission slots, as well as the timing for the (optional) additional signaling and data transmission period in phase (4a) of the Scheduled Channel Access frame. For every upcoming data transmission slot, the signaling information designates a primary UE and zero or more backup scheduling UEs, which stay awake in case the primary UEs fail clear channel assessment (CCA) so that backup UEs can be scheduled instead. A CCA failure may occur for various reasons, including where the channel is sensed as being busy. This approach allows flexible allocation and high frame utilization.

A duration of the data transmission slots is selected to approximately match the expected transmission duration for the primary UE's data. Hence, different transmission slots might have different duration, which also helps provide flexible allocation. Slots for transmissions to/from the same UE (e.g., DL+UL slots for the same UE), as well as transmissions using the same direction/beam, are grouped together. This allows COT sharing and reduces sensing overhead. When grouping together the slots for transmissions to/from the same UE and transmissions using the same direction/beam, another CCA is not required. Primary and back-up UEs are selected in a way that different transmission directions/beams must be used for these UEs. Doing so means that if CCA fails for the primary UE, transmissions to/from back-up UEs can be still attempted (if channel is sensed clear in their direction).

### Data Transmission Phase

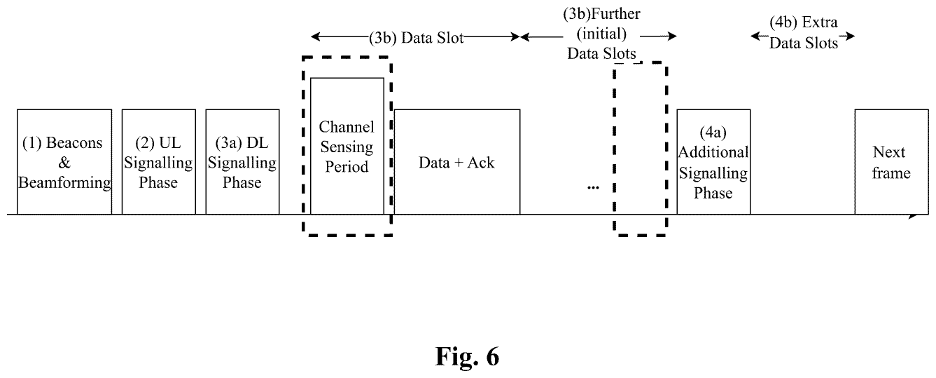

FIG. 6 is an example Scheduled Channel Access Frame Structure according to example embodiments highlighting an example data transmission phase according to example embodiments. In one embodiment, the data transmission period may include CCA, channel sounding, and access reservation.

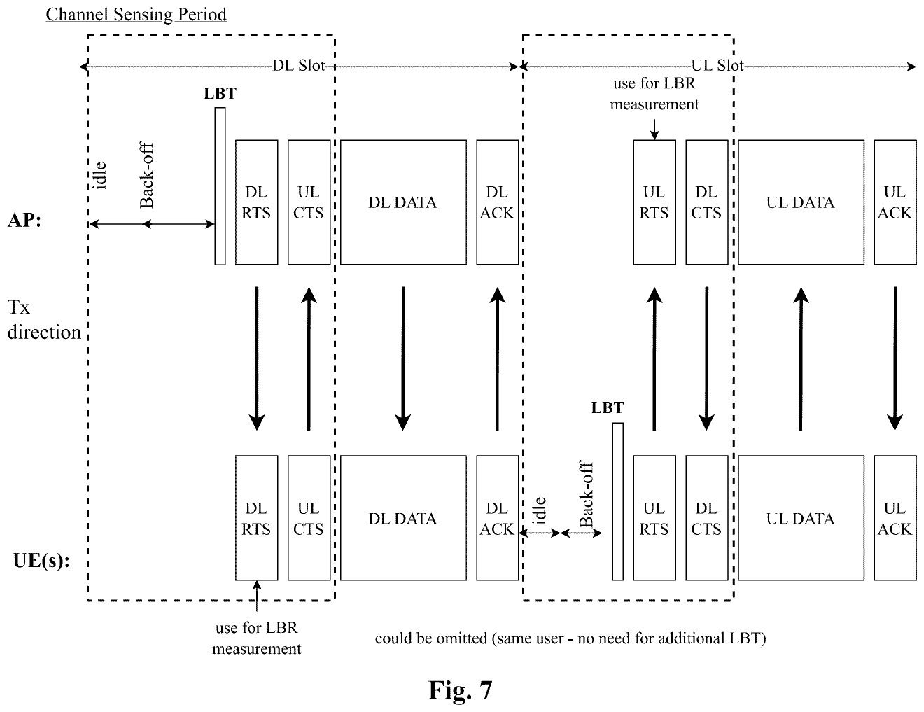

FIG. 7 is an example diagram illustrating an example channel sensing period according to example embodiments. Referring to FIG. 7, individual data slots have a channel sensing period which combines an idle and back-off period (to comply with regulations or standards), a Listen-Before-Talk (LBT) period for CCA (directional), and Request-to-Send (RTS) and Clear-to-Send (CTS) exchange. In one embodiment, for sub-THz systems in unlicensed bands, directional LBT may need to be performed. For sub-THz systems in unlicensed bands, transmissions and also the interference situation will be highly directive, e.g., with strong interference from some directions and low interference from other directions. Thus, LBT may have to be performed directionally where the CCA result will depend on the direction of the communication peer relative to directional interference sources.

In some example embodiments, the RTS and CTS exchange is used simultaneously for access reservation and channel sounding on full data transmission bandwidth, thereby allowing control to use reduced bandwidth (BW). Reference signals in the RTS message are utilized as a Listen-Before-Receive measurement to estimate the DL channel signal to interference and noise ratio, which is fed back via the CTS message to allow AP-side link adaptation, or skipping of Tx in case of too much interference or bad link conditions.

Still referring to FIG. 7, if CCA for that UE fails (due to LBT and/or LBR), the AP can communicate to the UE that it should listen for the next (additional) DL CCS for further scheduling information (e.g., by using a “short control signaling” exception for short notification in DL RTS or DL CTS slot). In addition, the AP is able to schedule other UEs/transmission directions by picking another UE from the group of backup UEs that were previously signaled to stay awake. In one embodiment, the channel sensing period can be applied selectively and can be configured to be skipped for following slots if the same UE (also for alternating DL/UL) or communication direction is used, hence allowing COT sharing and reducing overhead.

### Additional Scheduling Phase

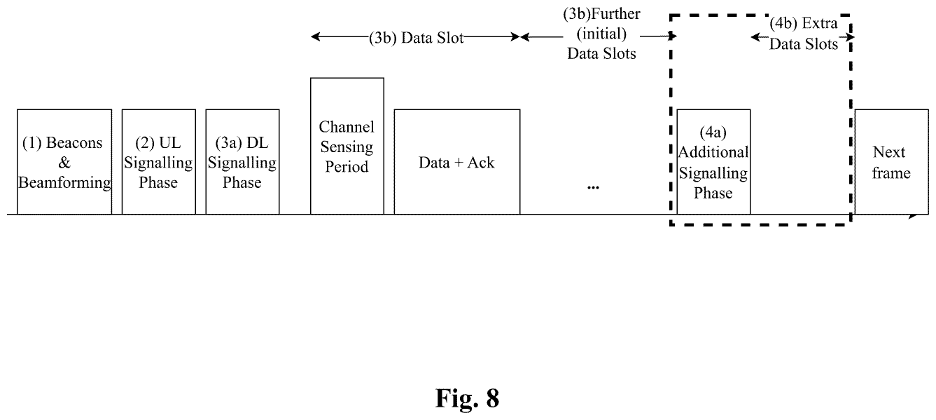

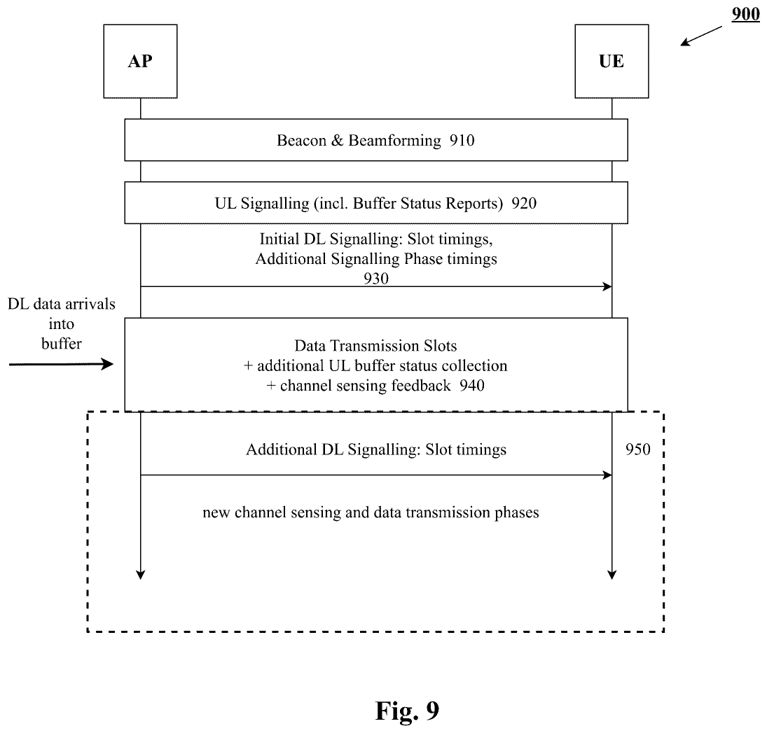

FIG. 8 is an example diagram illustrating an example additional signaling phase according to example embodiments. The additional signaling phase can provide frame extension and reconfiguration in some embodiments. As will be described in greater detail below, the additional signaling phase may include additional timing information. This additional timing information may follow the initial slot timings. For example, during the initial slot timings, the AP gathers the following information: DL data arrivals into an AP buffer, UL buffer reports from the UEs, and Clear Channel Assessment feedback from the UEs. Based on the collected information, the AP signals to the UEs additional slot timings, either to repeat the transmissions (if CCA failed), or to transmit/receive additional UL/DL data which arrived in the buffer. This additional signaling will be described in more detail below with respect to FIG. 9.

FIG. 9 is an example flow diagram 900 illustrating exchange of information between an AP and a UE in an example additional signaling phase according to example embodiments. The UE may be similar to, and have the functionality of, UE 110 disclosed herein. As previously discussed above with respect to FIG. 4, each frame includes: (1) a beacon and beamforming period; and (2) an uplink (UL) signaling phase. In one embodiment, the AP and the UE may exchange the information for the beacon and beamforming (910) and the UL signaling (920) according to known methods. The UL signaling may include buffer status reports from the UE in one embodiment.

Initial DL signaling is then sent from the AP to the UE (930). The initial DL signaling may include timing for initial data transmission slots, which includes primary UE and (potentially) backup UEs listening for control signals. Using backup UEs gives the APs flexibility to choose another UE in case of a LBT fail and allows the rest of the UEs to sleep in some embodiments. In addition, timing for an optional on-demand Additional Signaling Phase may be sent from the AP to the UE. As described above, this additional timing information typically should follow the initial slot timings. During the initial slot timings, the AP gathers the following information: DL data arrivals into an AP buffer, UL buffer reports from the UEs, and Clear Channel Assessment feedback from the UEs (940). Based on the collected information, the AP signals to the UEs additional slot timings, either to repeat the transmissions (if CCA failed), or to transmit/receive additional UL/DL data which arrived in the buffer (950).

By using the methods, devices, and flexible frame structures disclosed herein, directional unlicensed access in the sub-THz band may be achieved without wasting resources and without experiencing high latency. Although the examples herein were discussed with respect to the sub-THz band, the benefits of the disclosed examples are not limited to the sub-THz band, but may be utilized in other frequency ranges, particularly higher frequency ranges and in the unlicensed spectrum, e.g., millimeter (mm) wave.

### EXAMPLES

In a first example, a method performed by a user equipment (UE), comprising decoding, from signaling received from an access point (AP), channel access scheduling information that includes at least one frame with a configurable number of data transmission slots and configuring transceiver circuitry to transmit data and clear channel assessment (CCA) information to the AP, wherein the data and the CCA information are transmitted in one or more data transmission slots selected from the configurable number of data transmission slots based on the channel access scheduling information.

In a second example, the method of the first example, wherein one or more of the data transmission slots include a channel sensing period which combines channel sounding, clear channel assessment, and access reservation mechanisms.

In a third example, the method of the first example, wherein the channel access scheduling information comprises scheduling information for directional access in an unlicensed spectrum.

In a fourth example, the method of the first example, wherein a duration of the frame is chosen to match a maximum allowed Channel Occupancy Time (COT).

In a fifth example, the method of the first example, wherein the frame includes a downlink signaling phase, a data transmission phase, an additional scheduling phase and an additional data transmission phase.

In a sixth example, the method of the fifth example, wherein the channel access scheduling information comprises initial downlink signaling information to be included in the downlink signaling phase, and wherein the downlink signaling information comprises information about timing and direction of upcoming data transmission slots.

In a seventh example, the method of the sixth example, wherein the downlink signaling information further comprises timing information for the additional scheduling phase.

In an eighth example, the method of the seventh example, wherein the downlink signaling information further comprises information to designate the UE as either a primary UE or a backup UE for the frame duration, and if the UE is designated as a backup UE, the timing information is to be used by the UE to know when to be available in the additional scheduling phase.

In a ninth example, the method of the sixth example, wherein a duration of one or more of the data transmission slots is selected to match an expected transmission duration for data of the primary UE, such that different transmission slots may have a different duration.

In a tenth example, the method of the sixth example, wherein the data transmission slots for transmissions to/from the same UE, and transmissions using a same direction/beam, are grouped together.

In an eleventh example, the method of the tenth example, wherein only a single initial clear channel assessment need be performed.

In a twelfth example, the method of the first example, wherein each of the data transmission slots has a channel sensing period which combines an idle and back-off period, a directional Listen-Before-Talk (LBT) period for CCA, and a period for Request-to-Send (RTS) and Clear-to-Send (CTS) message exchange.

In a thirteenth example, the method of the twelfth example, wherein the RTS and CTS message exchange is used simultaneously for access reservation and channel sounding on full data transmission bandwidth.

In a fourteenth example, the method of the thirteenth example, wherein reference signals in the RTS message are utilized as a Listen-Before-Receive measurement to estimate a quality metric, which is fed back via the CTS message to the AP to allow AP-side link adaptation.

In a fifteenth example, the method of the fourteenth example, wherein if CCA for the UE fails, the channel access scheduling information further includes timing information to inform the UE that the UE should listen for further scheduling information in a slot for DL RTS or DL CTS.

In a sixteenth example, the method of the twelfth example, wherein the channel access scheduling information further includes an indication to selectively apply the channel sensing period and to skip the channel sensing period if transmissions are to/from the same UE, and/or transmissions are using a same direction/beam.

In a seventeenth example, the method of the fifth example, wherein the channel access scheduling information comprises downlink signaling information to be included in the downlink signaling phase, the downlink signaling information comprising initial timing information for initial data transmission slots and additional timing information for data transmission slots in the additional signaling phase.

In an eighteenth example, the method of the seventeenth example, wherein the processing circuitry is configured to configure transceiver circuitry to, during the initial data transmission slots, transmit uplink buffer reports to the AP, and transmit CCA assessment feedback to the AP.

In a nineteenth example, the method of the eighteenth example, wherein the channel access scheduling information further includes information to inform the UE whether the UE is a primary UE or a backup UE for the frame duration, and if the UE is designated as a backup UE, the timing information to be used by the UE to know when to be available in the additional scheduling phase; and wherein if the UE is the primary UE and CCA for the UE fails, the downlink signaling information being configured to instruct the UE to retry data transmissions during the data transmission slots in the additional signaling phase.

In a twentieth example, the method of the eighteenth example, wherein the channel access scheduling information further includes an instruction to the UE to transmit and/or receive additional UL and/or DL data during the data transmission slots in the additional signaling phase.

In a twenty first example, a processor configured to perform any of the methods of the first through twentieth examples.

In a twenty second example, a user equipment (UE) comprising a transceiver configured to communicate with an access point (AP) and a processor communicatively coupled to the transceiver and configured to perform any of the methods of the first through twentieth examples.

In a twenty third example, a method performed by an access point (AP), comprising configuring transceiver circuitry to transmit channel access scheduling information to one or more of a plurality of user equipment (UE(s)), the channel access scheduling information including at least one frame with a configurable number of data transmission slots and decoding, from signaling received from one or more of the plurality of UEs, data and clear channel assessment (CCA) information, wherein the data and the CCA information are transmitted in one or more data transmission slots selected from the configurable number of data transmission slots based on the channel access scheduling information.

In a twenty fourth example, the method of the twenty third example, wherein one or more of the data transmission slots include a channel sensing period which combines channel sounding, clear channel assessment, and access reservation mechanisms.

In a twenty fifth example, the method of the twenty third example, wherein the channel access scheduling information comprises scheduling information for directional access in an unlicensed spectrum.

In a twenty sixth example, the method of the twenty third example, wherein a duration of the frame is chosen to match a maximum allowed Channel Occupancy Time (COT).

In a twenty seventh example, the method of the twenty third example, wherein the frame includes a downlink signaling phase, a data transmission phase, and an additional scheduling phase.

In a twenty eighth example, the method of the twenty seventh example, wherein the channel access scheduling information comprises initial downlink signaling information to be included in the downlink signaling phase, and wherein the downlink signaling information comprises information about timing and direction of upcoming data transmission slots.

In a twenty ninth example, the method of the twenty eighth example, wherein the downlink signaling information further comprises timing information for the additional scheduling phase.

In a thirtieth example, the method of the twenty ninth example, wherein the channel access scheduling information is transmitted omnidirectionally for each of the data transmission slots to two or more of the plurality of UEs, and wherein the downlink signaling information further comprises information to designate one of the plurality of UEs as a primary UE for the frame duration and to designate another one or more of the plurality of UEs as back up UE(s) for the frame duration, and if the UE is designated as a backup UE, the timing information for the additional signaling phase to be used by the backup UE to know when to be available in the additional scheduling phase.

In a thirty first example, the method of the thirtieth example, wherein a duration of one or more of the data transmission slots is selected to match an expected transmission duration for data of the primary UE, such that different transmission slots may have a different duration.

In a thirty second example, the method of the thirtieth example, wherein the data transmission slots for transmissions to/from the same UE, and transmissions using a same direction/beam, are grouped together.

In a thirty third example, the method of the thirty second example, wherein only a single initial clear channel assessment need be performed.

In a thirty fourth example, the method of the thirtieth example, wherein the channel access scheduling information is configured to select the primary and back-up UEs in a way that different transmission directions/beams are used for the primary and back up UEs such that if CCA fails for the primary UE, transmissions to/from the back-up UE can be still attempted if a channel is sensed clear in the direction of the backup UE.

In a thirty fifth example, the method of the twenty third example, wherein each of the data transmission slots has a channel sensing period which combines an idle and back-off period, a directional Listen-Before-Talk (LBT) period for CCA, and a period for Request-to-Send (RTS) and Clear-to-Send (CTS) message exchange.

In a thirty sixth example, the method of the thirty fifth example, wherein the RTS and CTS message exchange is used simultaneously for access reservation and channel sounding on full data transmission bandwidth.

In a thirty seventh example, the method of the thirty sixth example, wherein reference signals in the RTS message are utilized as a Listen-Before-Receive measurement to estimate a DL channel signal to interference and noise ratio (SINR), which is fed back via the CTS message to the transmitter to allow transmitter side link adaptation.

In a thirty eighth example, the method of the thirty seventh example, wherein if CCA for the UE fails, the channel access scheduling information further includes timing information to inform the UE that the UE should listen for further scheduling information in a slot for DL RTS or DL CTS.

In a thirty ninth example, the method of the thirtieth example, wherein if CCA for the UE fails, the channel access scheduling information is further configured to schedule other UEs or provide other transmission directions by designating a UE from the back up UE(s) to perform a data transmission.

In a fortieth example, the method of the thirty fifth example, wherein the channel access scheduling information further includes an indication to selectively apply the channel sensing period and to skip the channel sensing period if transmissions are to/from the same UE, and/or transmissions are using a same direction/beam.

In a forty first example, the method of the twenty eighth example, wherein the channel access scheduling information comprises downlink signaling information to be included in the downlink signaling phase, the downlink signaling information comprising initial timing information for initial data transmission slots and additional timing information for data transmission slots in the additional signaling phase.

In a forty second example, the method of the forty first example, wherein the processing circuitry is configured to, during the initial data transmission slots, receive downlink data to be transmitted to the UE, receive uplink buffer reports from the UE, and receive CCA assessment feedback from the UE.

In a forty third example, the method of the forty second example, wherein the channel access scheduling information further includes information to inform the UE whether the UE is a primary UE or a backup UE for the frame duration, and if the UE is designated as a backup UE, the timing information to be used by the UE to know when to be available in the additional scheduling phase; and wherein if the UE is the primary UE and CCA for the UE fails, the downlink signaling information being configured to instruct the UE to start a new CCA procedure and retry data transmissions during the data transmission slots in the additional signaling phase.

In a forty fourth example, the method of the forty second example, wherein the channel access scheduling information further includes an instruction to the UE to transmit and/or receive additional UL and/or DL data during the data transmission slots in the additional signaling phase.

In a forty fifth example, a processor configured to perform any of the methods of the twenty third through forty fourth examples.

In a forty sixth example, an access point (AP) comprising a transceiver configured to communicate with a user equipment (UE) and a processor communicatively coupled to the transceiver and configured to perform any of the methods of the twenty third through forty fourth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A system, comprising:
a user equipment (UE) configured to:
receive channel access scheduling information that includes at least one frame with a configurable number of data transmission slots, wherein the frame includes a downlink signaling phase, a data transmission phase, an additional scheduling phase and an additional data transmission phase; and
transmit data and clear channel assessment (CCA) information, wherein the data and the CCA information are transmitted in one or more data transmission slots selected from the configurable number of data transmission slots based on the channel access scheduling information; and
an access point (AP) configured to:
transmit the channel access scheduling information to the UE; and
receive the data and clear channel assessment (CCA) information from the UE.

2. An apparatus of a user equipment (UE), the apparatus comprising processing circuitry configured to:
decode, from signaling received from an access point (AP), channel access scheduling information that includes at least one frame with a configurable number of data transmission slots; and
configure transceiver circuitry to transmit data and clear channel assessment (CCA) information to the AP, wherein the data and the CCA information are transmitted in one or more data transmission slots selected from the configurable number of data transmission slots based on the channel access scheduling information.

3. The apparatus of claim 2, wherein one or more of the data transmission slots include a channel sensing period which combines channel sounding, clear channel assessment, and access reservation mechanisms.

4. The apparatus of claim 2, wherein the channel access scheduling information comprises scheduling information for directional access in an unlicensed spectrum.

5. The apparatus of claim 2, wherein a duration of the frame is chosen to match a maximum allowed Channel Occupancy Time (COT).

6. The apparatus of claim 2, wherein the frame includes a downlink signaling phase, a data transmission phase, an additional scheduling phase and an additional data transmission phase.

7. The apparatus of claim 6, wherein the channel access scheduling information comprises initial downlink signaling information to be included in the downlink signaling phase, and wherein the downlink signaling information comprises information about timing and direction of upcoming data transmission slots.

8. The apparatus of claim 7, wherein the downlink signaling information further comprises timing information for the additional scheduling phase.

9. The apparatus of claim 8, wherein the downlink signaling information further comprises information to designate the UE as either a primary UE or a backup UE for the frame duration, and if the UE is designated as a backup UE, the timing information is to be used by the UE to know when to be available in the additional scheduling phase.

10. The apparatus of claim 7, wherein a duration of one or more of the data transmission slots is selected to match an expected transmission duration for data of the primary UE, such that different transmission slots may have a different duration.

11. The apparatus of claim 7, wherein the data transmission slots for transmissions to/from the same UE, and transmissions using a same direction/beam, are grouped together.

12. The apparatus of claim 11, wherein only a single initial clear channel assessment need be performed.

13. The apparatus of claim 1, wherein each of the data transmission slots has a channel sensing period which combines an idle and back-off period, a directional Listen-Before-Talk (LBT) period for CCA, and a period for Request-to-Send (RTS) and Clear-to-Send (CTS) message exchange.

14. The apparatus of claim 13, wherein the RTS and CTS message exchange is used simultaneously for access reservation and channel sounding on full data transmission bandwidth.

15. The apparatus of claim 14, wherein reference signals in the RTS message are utilized as a Listen-Before-Receive measurement to estimate a quality metric, which is fed back via the CTS message to the AP to allow AP-side link adaptation.

16. The apparatus of claim 15, wherein if CCA for the UE fails, the channel access scheduling information further includes timing information to inform the UE that the UE should listen for further scheduling information in a slot for DL RTS or DL CTS.

17. The apparatus of claim 13, wherein the channel access scheduling information further includes an indication to selectively apply the channel sensing period and to skip the channel sensing period if transmissions are to/from the same UE, and/or transmissions are using a same direction/beam.

18. The apparatus of claim 6, wherein the channel access scheduling information comprises downlink signaling information to be included in the downlink signaling phase, the downlink signaling information comprising:
initial timing information for initial data transmission slots; and
additional timing information for data transmission slots in the additional signaling phase.

19. The apparatus of claim 18, wherein the processing circuitry is configured to configure transceiver circuitry to, during the initial data transmission slots, transmit uplink buffer reports to the AP, and transmit CCA assessment feedback to the AP.

20. An apparatus of an access point (AP), the apparatus comprising processing circuitry configured to:
configure transceiver circuitry to transmit channel access scheduling information to one or more of a plurality of user equipment (UE(s)), the channel access scheduling information including at least one frame with a configurable number of data transmission slots; and
decode, from signaling received from one or more of the plurality of UEs, data and clear channel assessment (CCA) information, wherein the data and the CCA information are transmitted in one or more data transmission slots selected from the configurable number of data transmission slots based on the channel access scheduling information.
